(19) United States
(12) Patent Application Publication
(10) Pub. No.: US 2024/0007895 A1
(43) Pub. Date: Jan. 4, 2024

(54) COMMUNICATION CONTROL DEVICE, COMMUNICATION CONTROL METHOD AND RECORDING MEDIUM

(71) Applicant: NEC Corporation, Tokyo (JP)

(72) Inventors: Youji TAYAMA, Tokyo (JP); Takayuki MIYAGAKI, Tokyo (JP)

(73) Assignee: NEC Corporation, Tokyo (JP)

(21) Appl. No.: 18/214,866

(22) Filed: Jun. 27, 2023

(30) Foreign Application Priority Data
Jul. 1, 2022 (JP) 2022-106910

(51) Int. Cl. H04W 28/02; H04L 47/62

(52) U.S. Cl. CPC H04W 28/0268; H04L 47/6215

(57) ABSTRACT

A communication control device includes: a reception unit that receives a packet; an identification unit that identifies a network slice to which the packet belongs and a class of the packet in a QoS; a distribution unit that, according to an identification result of the packet, distributes the packet to any of queues of a queue grouping; a plurality of data transfer units that perform packet transfer processing according to the QoS in the associated network slice; and a transmission unit that transmits, through a physical port, the packet received from the data transfer unit. Each of the plurality of data transfer units acquires a packet from a queue group associated with the network slice associated with the data transfer unit, and the transmission unit transmits, with higher priority, the packet received from the data transfer unit associated with the network slice having a higher slice priority level.

This application is based upon and claims the benefit of priority from Japanese Patent Application No. 2022-106910, filed on Jul. 1, 2022, the disclosure of which is incorporated herein in its entirety by reference.

### TECHNICAL FIELD

The present invention relates to a communication control device and the like.

### BACKGROUND ART

3rd Generation Partnership Project (3GPP) (registered trademark) standardizes 5th generation (5G). As also described in NPL 1 (3GPP TS 23.501 V16.3.0, “System architecture for the 5G System (5GS)”, 2019/12), the 5G system includes a 5G access network (AN), a 5G core network (CN), and user equipment (UE).

In the 5G, as representative usage scenarios, discussed are communications such as massive Internet of things (mIOT), an enhanced Mobile Broadband (eMBB), and Ultra Reliable Low Latency Communications (URLLC). These communications are different from one another in traffic characteristics, and have difficulty in meeting traffic requirements at the same time in all the communications. For example, in the eMBB where a large capacity is required, packet transfer by bulk processing is optimum. However, the bulk processing is apt to cause a jitter. Therefore, the packet transfer by the bulk processing has difficulty in achieving low latency and high quality, which are required for the URLLC. For such different traffic requests, it is discussed in the 5G that a communication is divided and implemented in a form of a network slice.

In the 5G system, a network slice having different traffic requirements is divided as a plurality of network slice instances (NSIs). Moreover, specific portions (for example, an access network, a core network, and the like) of the NSIs are defined as network slice sub-nets instances (NSSIs). Particularly, the NSSI of the core network is not shared with a different NSI, and is individually allocated.

The network slice of the core network constitutes a network function (NF) of the core network, based on single-network slice selection assistance information (S-NSSAI) exchanged between the UE, the AN, and the CN. The configuration of the NF depends on an operator or a vendor. However, in every configuration, a session management function (SMF) and a user plane function (UPF) are defined as NFs to be allocated for each network slice.

The UPF is in charge of user-plane (U-Plane) control (user packet control), and accommodates a U-Plane communication. The UPF is individually allocated by a control-plane (C-Plane) such as an access and mobility management function (AMF) and a network slice selection function (NSSF), which receives the S-NSSAI, and is connected to the access network. The UPF is individually allocated, and thereby, quality of service (QoS) of the user packet is achieved in each network slice.

As mentioned above, the UPF is allocated for each network slice. In such a case, there occur division losses of hardware/software resources such as a central processing unit (CPU), a power supply capacity and a physical space, and management/operation cost increases. In order to suppress such cost, it is conceived to accommodate a U-Plane communication with a plurality of network slices in one UPF.

As a technique for accommodating a U-Plane communication with a plurality of network slices in one UPF, there is a method described in PTL 1. In such a method, the UPF identifies a network slice to which a received packet belongs and a class thereof in the QoS. Then, the UPF distributes the received packet into a queue grouping. This queue grouping has a plurality of queue groups being associated with a plurality of network slices. Each of the queue groups is associated with a plurality of the classes in the QoS. Then, each of a plurality of data transfer means acquires the received packet from a queue associated with each class of the queue group being associated therewith, and performs, for the received packet, packet transfer processing according to the QoS. Further, PTL 1 describes that the UPF is achieved by a smart network interface card (NIC) and the CPU, and that the above-mentioned data transfer means is achieved by the CPU, and the queue grouping is achieved by the smart NIC.

PTL 1 (Japanese Unexamined Patent Application Publication No. 2021-170729) describes that a packet is received by the smart NIC, and the received packet is transferred by the CPU, but does not describe that the smart NIC receives a packet from the CPU and transmits the received packet to outside of the UPF.

When the smart NIC transmits the packet to the outside of the UPF, the smart NIC receives the packet from the CPU. However, with regard to the packet received from the CPU, the smart NIC cannot recognize information on a network slice to which the packet belongs.

The information on the network slice to which the packet belongs is identified by the smart NIC when the packet is received from the outside of the UPF, and is used for distributing the received packet to the queue. However, the packet is transferred by the CPU. Moreover, the information on the network slice is not added to the packet, and accordingly, at a point of time when the smart NIC receives the packet from the CPU, the smart NIC cannot recognize the information on the network slice to which the packet belongs.

Therefore, the smart NIC has a problem of transmitting packets to which the same priority level is set, with the same priority level to the outside of the UPF even when the packets belong to different network slices.

A use case of the network slice is provided with a 5G QoS identifier (5QI) (refer to NPL 1). In the Internet Engineering Task Force (IETF), with regard to the 5QI, discussed is mapping thereof with a differentiated services code point (DSCP) which an internet protocol (IP) header has. For example, a DSCP included in a layer 3 (L3) IP header of a user packet is being used as one of values representing the QoS. For example, it is assumed that a DSCP of a packet of a network slice A is “EF” representing an emergency packet to be processed with the highest priority, and that a DSCP of a packet of another network slice B is also “EF”. In such a case, priority levels of the two packets are the same, and accordingly, it is not assured which packet the smart NIC transmits first to the outside of the UPF.

As described above, even when a priority level of the network slice A and a priority level of the network slice B are different from each other, the smart NIC transmits the packets, to which the same DSCP is set (that is, the packets with the same priority level), at the same priority level to the outside of the UPF.

### SUMMARY

In view of the above-mentioned problem, an object of the present invention is to provide a communication control device and the like that enable transmitting a packet according to a priority level of a network slice to which the packet belongs in a case of accommodating communications of a plurality of network slices.

In one aspect of the present invention, a communication control device includes: a reception unit configured to receive a packet through a physical port; an identification unit configured to identify, with regard to the received packet, a network slice to which the packet belongs and a class of the packet in a QoS; a distribution unit configured to distribute the packet to any of queues of a queue grouping, according to an identification result of the packet, the queue grouping including a plurality of queue groups associated with each of a plurality of the network slices, the plurality of queue groups each including a plurality of the queues associated with each of a plurality of classes in the QoS; a plurality of data transfer units each being provided to each of the plurality of network slices and configured to perform packet transfer processing according to the QoS in the associated network slice; and a transmission unit configured to transmit, through a physical port, the packet received from the data transfer unit, wherein each of a plurality of the data transfer units acquires the packet from the queue included in the queue group associated with the network slice associated with the data transfer unit, and performs the packet transfer processing according to the QoS on the acquired packet, and the transmission unit transmits, with higher priority, the packet received from, among a plurality of the data transfer units, the data transfer unit associated with the network slice having a higher slice priority level being a priority level of the network slice.

In another aspect of the present invention, a communication control method includes: receiving a packet through a physical port; identifying, with regard to the received packet, a network slice to which the packet belongs and a class of the packet in a QoS; distributing the packet to any of queues of a queue grouping according to an identification result of the packet, the queue grouping including a plurality of queue groups associated with each of a plurality of the network slices, the plurality of queue groups each including a plurality of the queues associated with each of a plurality of classes in the QoS; in a data transfer unit each provided to each of a plurality of the network slices, acquiring the packet from the queue included in the queue group associated with the network slice associated with the data transfer unit, and performing packet transfer processing according to the QoS on the acquired packet; and transmitting, through a physical port, with higher priority, the packet received from, among a plurality of the data transfer units, the data transfer unit associated with the network slice with a higher slice priority level being a priority level of the network slice.

Further, in another aspect of the present invention, a communication control program being recorded on a non-transitory computer-readable recording medium causes a computer to achieve: a reception function of receiving a packet through a physical port; an identification function of, with regard to the received packet, identifying a network slice to which the packet belongs and a class of the packet in a QoS; a distribution function of distributing the packet to any of queues of a queue grouping according to an identification result of the packet, the queue grouping including a plurality of queue groups associated with each of a plurality of the network slices, the plurality of queue groups each including a plurality of the queues associated with each of a plurality of classes in the QoS; a plurality of data transfer functions, each being provided to each of a plurality of the network slices, of performing packet transfer processing according to the QoS in the associated network slice; and a transmission function of transmitting, through a physical port, the packet received from the data transfer function, wherein each of a plurality of the data transfer functions acquires the packet from the queue included in the queue group associated with the network slice being associated with the data transfer function, and performs the packet transfer processing according to the QoS on the acquired packet, and the transmission function transmits, with higher priority, the packet received from, among a plurality of the data transfer functions, the data transfer function associated with the network slice having a higher slice priority level being a priority level of the network slice.

### BRIEF DESCRIPTION OF THE DRAWINGS

Exemplary features and advantages of the present invention will become apparent from the following detailed description when taken with the accompanying drawings in which:

FIG. 1 is a diagram illustrating a configuration example of a communication control device of a first example embodiment of the present invention;

FIG. 2 is a diagram illustrating an example of an operation flow of the communication control device of the first example embodiment of the present invention;

FIG. 3 is a diagram illustrating a configuration example of a system including a communication control device of a second example embodiment of the present invention;

FIG. 4 is a diagram illustrating a configuration example of the communication control device of the second example embodiment of the present invention;

FIG. 5 is a diagram illustrating an example of a table for use in identifying network slices of the communication control device of the second example embodiment of the present invention;

FIG. 6 is a diagram illustrating another example of the table for use in identifying the network slices of the communication control device of the second example embodiment of the present invention;

FIG. 7 is a diagram illustrating a configuration example of queue groups owned by the communication control device of the second example embodiment of the present invention;

FIG. 8 is a diagram illustrating an example of a correspondence relationship between a data transfer unit and the queue groups in the communication control device of the second example embodiment of the present invention;

FIG. 9 is a diagram illustrating an example of a relationship between the data transfer unit and slice priority levels in the communication control device of the second example embodiment of the present invention;

FIG. 10 is a diagram illustrating an example of an operation flow of the communication control devices of the second and third example embodiments of the present invention;

FIG. 11 is a diagram illustrating an example of the operation flow of the communication control devices of the second and third example embodiments of the present invention;

FIG. 12 is a diagram illustrating an example of an operation flow of the communication control devices of the second and third example embodiments of the present invention;

FIG. 13 is a diagram illustrating a configuration example of the communication control device of the third example embodiment of the present invention; and

FIG. 14 is a diagram illustrating a hardware configuration example of each of the example embodiments of the present invention.

### EXAMPLE EMBODIMENT

### First Example Embodiment

A first example embodiment of the present invention will be described. Specific examples of a communication control device 10 according to the first example embodiment are a communication control device 20 according to a second example embodiment to be described later and a communication control device 30 according to a third example embodiment to be described later.

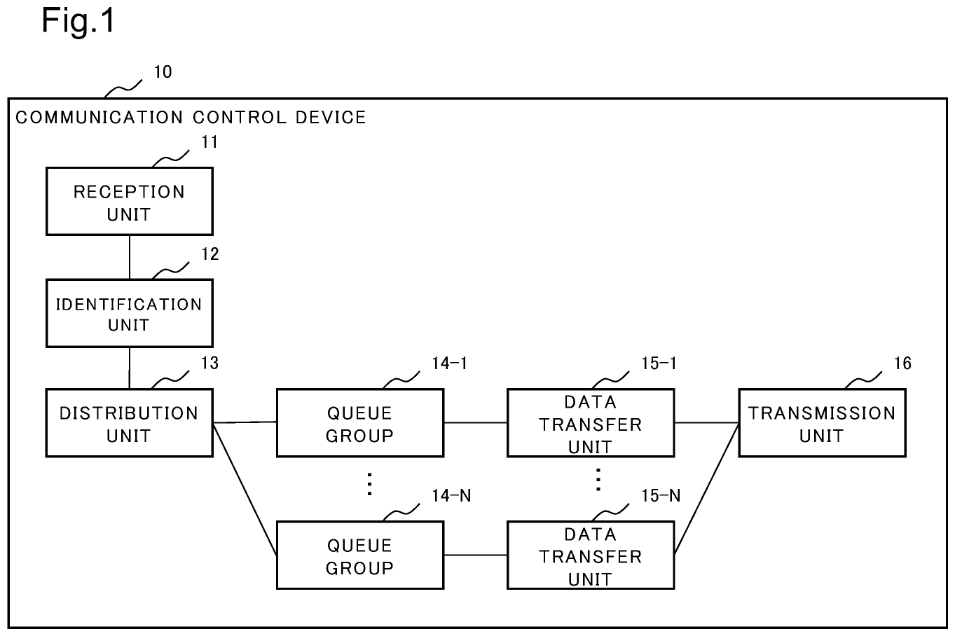

FIG. 1 illustrates a configuration example of the communication control device 10 according to the present example embodiment. The communication control device 10 includes a reception unit 11, an identification unit 12, a distribution unit 13, a queue group 14-i (i is an integer of 1 to N, inclusive), a data transfer unit 15-i (i is an integer of 1 to N, inclusive) and a transmission unit 16.

The reception unit 11 receives a packet through a physical port.

The identification unit 12 identifies, with regard to the received packet, a network slice to which the packet belongs and a class thereof in a QoS.

The distribution unit 13 distributes the packet to any queue of a queue grouping according to an identification result of the packet. The queue grouping includes a plurality of queue groups (14-1 to 14-N) associated respectively with a plurality of the network slices. Each of the queue groups includes a plurality of queues associated respectively with a plurality of the classes in the QoS.

A plurality of the data transfer units (15-1 to 15-N) are provided with respect to the network slices.

The data transfer unit 15-i acquires a packet from the queue of the queue group 14-i associated with the network slice being associated therewith, and performs packet transfer processing according to the QoS on the acquired packet.

The transmission unit 16 transmits packets, through the physical port, packets received from the data transfer units (15-1 to 15-N).

The transmission unit 16 transmits the packets received from the data transfer units (15-1 to 15-N), while giving priority to a packet received from the data transfer unit associated with a network slice with a higher slice priority level among the plurality of data transfer units (15-1 to 15-N). The slice priority level is a priority level of the network slice.

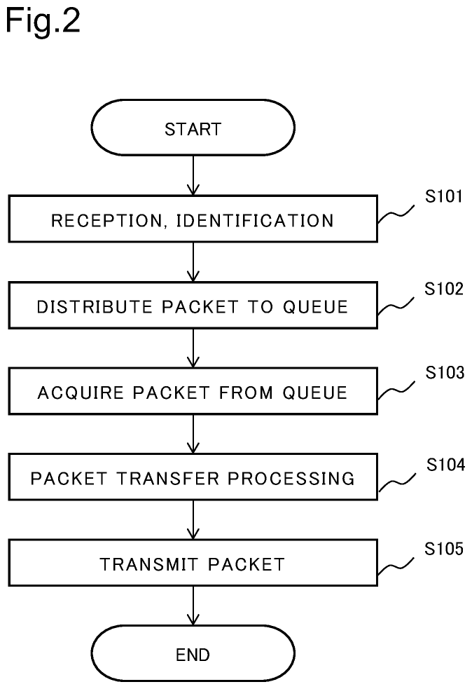

Next, FIG. 2 illustrates an example of an operation flow of the communication control device 10 according to the present example embodiment.

The reception unit 11 receives the packet through the physical port. With regard to the received packet, the identification unit 12 identifies the network slice to which the packet belongs and the class in the QoS (Step S101).

The distribution unit 13 distributes the packet to any queue of the queue grouping according to the identification result of the packet (Step S102).

The data transfer unit 15-i acquires the packet from the queue of the queue group 14-i associated with the network slice being associated therewith (Step S103), and performs packet transfer processing according to the QoS on the acquired packet (Step S104).

The transmission unit 16 transmits the packets received from the data transfer units (15-1 to 15-N) (Step S105). The transmission unit 16 transmits the packets while giving priority to the packet received from the data transfer unit associated with the network slice with a higher slice priority level. The slice priority level is a priority level of the network slice.

As described above, in the first example embodiment of the present invention, the communication control device 10 includes the reception unit 11, the identification unit 12, the distribution unit 13, the queue group 14-i, the data transfer unit 15-i and the transmission unit 16. The reception unit 11 receives a packet through a physical port. The identification unit 12 identifies, with regard to the received packet, a network slice to which the packet belongs and a class in the QoS. The distribution unit 13 distributes the packet to any queue of a queue grouping according to the identification result of the packet. The queue grouping has the plurality of queue groups (14-1 to 14-N) each associated with each of the plurality of network slices. Each of the queue groups includes the plurality of queues each associated with the plurality of classes in the QoS. The plurality of data transfer units (15-1 to 15-N) are associated with each of the network slices. The data transfer unit 15-i acquires the packet from the queue of the queue group 14-i associated with the network slice being associated therewith, and performs packet transfer processing according to the QoS on the acquired packet. The transmission unit 16 transmits the packets, which are received from the data transfer units (15-1 to 15-N), through the physical port. The transmission unit 16 transmits the packets while giving priority to the packet received from the data transfer unit associated with the network slice having a higher slice priority level. The slice priority level is a priority level of the network slice.

As described above, the communication control device 10 transmits the packets while giving priority to the packet received from the data transfer unit associated with the network slice having a higher slice priority level. Therefore, it becomes possible to transmit the packets according to the priority levels of the network slices to which the packets belong in the case of accommodating the communications of the plurality of network slices.

### Second Example Embodiment

Next, a communication control device 20 according the second example embodiment of the present invention will be described.

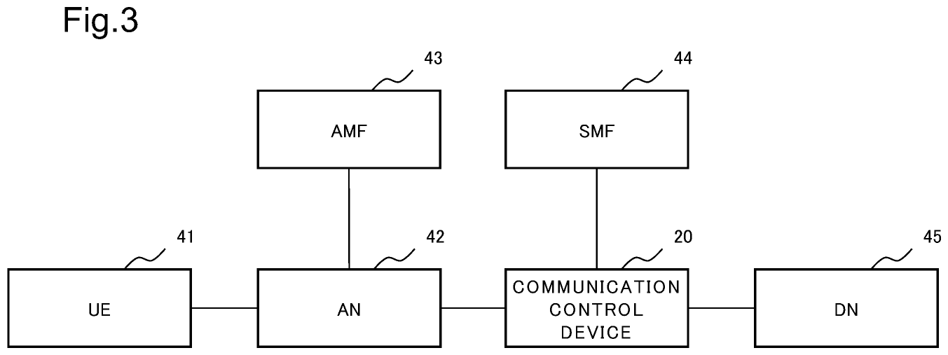

FIG. 3 illustrates a configuration example of a system including the communication control device 20. This system includes the communication control device 20, a UE 41, an 42, an AMF 43, an SMF 44 and a data network (DN) 45. The communication control device 20 according to the present example embodiment corresponds to a UPF.

The UE 41 includes user equipment such as a mobile telephone, a smartphone, a tablet, a personal computer (PC), and an Internet of Things (IoT) device. On the UE 41, a plurality of applications which communicate with the DN 45 may operate. The AN 42 includes a base station and the like, and connects the UE 41 and the 5G core network to each other. The AMF 43 performs mobility management. The AMF 43 performs terminal-level processing, for example, subscriber authentication and position management of the terminal.

The communication control device 20 (UPF) constitutes a part of the 5G core network. The communication control device 20 performs a user data communication between the UE 41 and the DN 45 that is an external network such as the Internet. The SMF 44 performs session management. The SMF 44 and the communication control device 20 establish a session, which is oriented for the DN 45, for each network slice. The plurality of applications which operate on the UE 41 connect to the network slices, each of which meets a traffic requirement thereof.

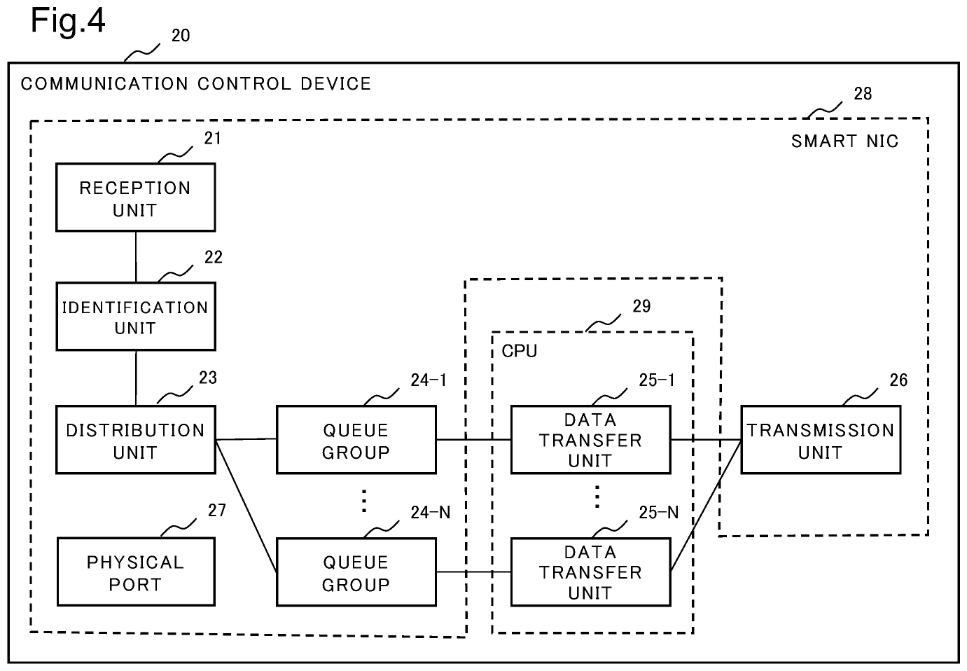

Next, FIG. 4 illustrates a configuration example of the communication control device 20 according to the present example embodiment. The communication control device 20 includes a smart NIC 28 and a CPU 29.

The CPU 29 includes a data transfer unit 25-i (i is an integer of 1 to N). For example, the communication control device 20 is configured as a physical server on which the smart NIC 28 is mounted. In the communication control device 20, a function of the data transfer unit 25-i is achieved, for example, by using a server virtual technology.

The data transfer unit 25-i is provided in association with an i-th network slice. Note that, in the present example embodiment, the number of network slices is N.

The data transfer unit 25-i performs the packet transfer processing, based on a signal transmitted from the SMF 44. The data transfer unit performs the packet transfer processing according to the QoS, in the network slice associated therewith. The data transfer unit 25-i acquires a packet from the smart NIC 28, and determines a packet transfer destination and the like. Moreover, the data transfer unit 25-i transmits the packet to the AN 42 or the DN 45 through the smart NIC 28. The data transfer unit performs the packet transfer processing according to the QoS in the network slice associated therewith. The packet transfer processing is, for example, a priority control, a bandwidth control or the like.

The smart NIC 28 includes a reception unit 21, an identification unit 22, a distribution unit 23, a queue group 24-i (i is an integer of 1 to N), a transmission unit 26 and a physical port 27. The smart NIC 28 is composed, for example, by using a field programmable gate array (FPGA). The smart NIC 28 may be composed by using other device, for example, a semiconductor device including a processor and a memory. In such a case, the identification unit 22 and the distribution unit 23 may be achieved by operating according to a program read out from the memory by the processor.

The physical port 27 receives packets from the AN 42 and the DN 45. Moreover, the physical port 27 transmits the packets to the AN 42 and the DN 45. The physical port 27 outputs the received packets to the reception unit 21. Moreover, the physical port 27 transmits the packet received from the transmission unit 26 to the AN 42 or the DN 45. The physical port 27 may be divided into an input port and an output port.

The reception unit 21 receives the packets through the physical port 27.

The identification unit 22 analyzes the packets received by the reception unit 21, and identifies the network slices to which the packets belong, and the classes in the QoS. The identification unit 22 identifies the network slice, for example, with reference to a specific range in each of the packets. The identification unit 22 identifies the class in the QoS, based on a Class of Service (CoS) value included in a Layer 2 (L2) Ethernet (registered trademark) frame of the packet.

For example, when the packet is a General Packet Radio Service (GPRS) Tunneling Protocol for User Plane (GTP-U) packet, the identification unit 22 is able to identify the network slice with reference to a range from the L2 Ethernet frame to the GTP-U Extension, which is taken as a specific range.

Moreover, when the packet is an IP packet, the identification unit 22 is able to identify the network slice with reference to a range from the L2 Ethernet frame to the L3 IP header, which is taken as a specific range.

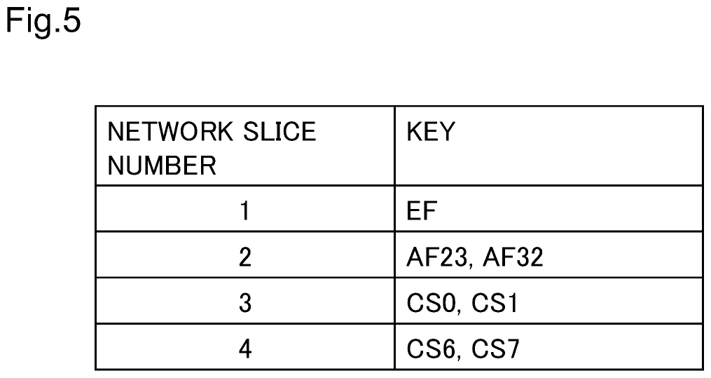

FIG. 5 illustrates one example of a table for use in identifying the network slices. The table is stored in a storage unit (not illustrated) in advance. This table illustrates a correspondence relationship between network slice numbers and distribution keys. Note that, in the case of the present example embodiment, the network slice numbers and the queue group numbers are the same. The identification unit 22 refers to the table, and when the packet includes a value or type information, which is designated as a distribution key, identifies a network slice associated with such distribution key as the network slice to which the packet belongs. For example, when the DSCP included in the L3 IP header is “EF” in the packet, the identification unit 22 identifies that the packet is a packet of a first network slice.

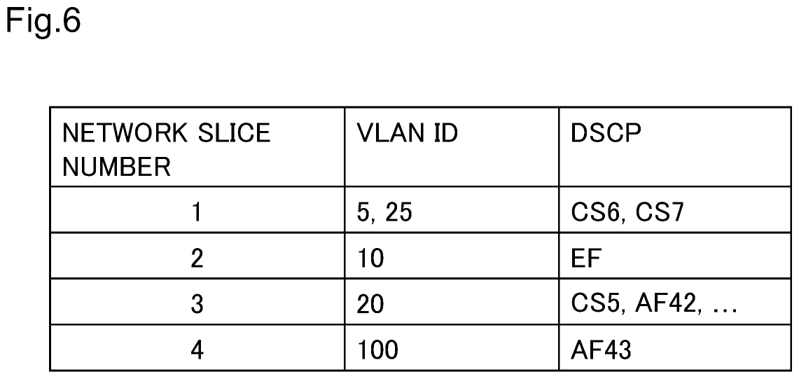

FIG. 6 illustrates another example of the table for use in identifying the network slice. In this example, a VLAN value (VLAN identifier (ID)) included in the L2 Ethernet frame and a DSCP included in the L3 IP header are designated as distribution keys. In such a case, the identification unit 22 identifies the network slice, based on a combination of the VLAN value and the DSCP. For example, in the case of VLAN ID=5 and DSCP=CS6 in the packet, the identification unit 22 identifies that the packet is the packet of the first network slice. As in this example, the distribution key may include values or type information of a plurality of fields in the packet.

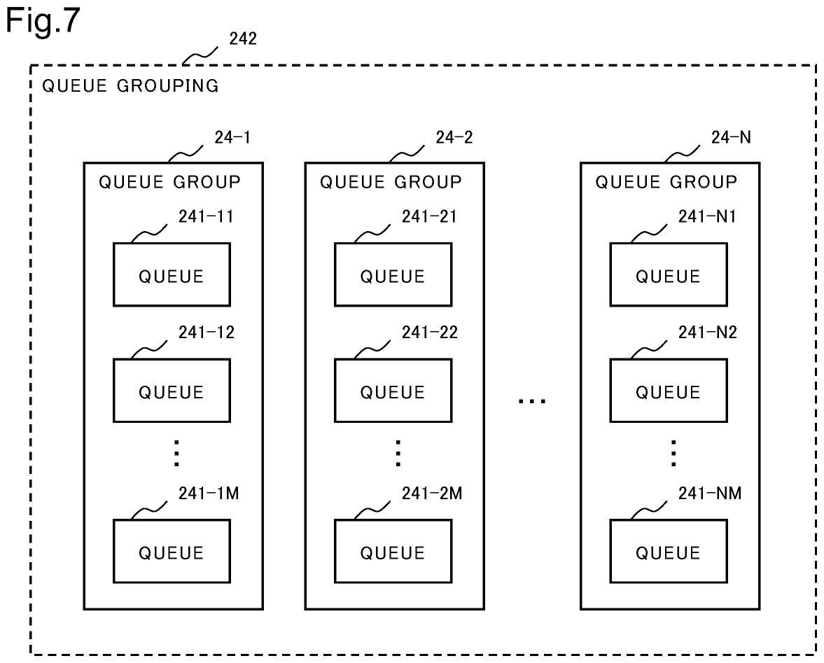

In the smart NIC 28, the queue group 24-i is associated with an i-th network slice. FIG. 7 illustrates a configuration example of the queue group 24-i.

The queue group 24-i includes a queue 241-ij (j is an integer of 1 to M). For example, queues 241-i1 to 241-i8 may be associated with classes to 7 in a QoS control of the i-th network slice. An aggregate of the queue groups 24-1 to 24-N is called a queue grouping 242.

The distribution unit 23 distributes the packet to any of the queues in the queue grouping 242, according to an identification result of the packet in the identification unit 22. For example, the distribution unit 23 stores the packet in the queue 241-ij associated with the identified class, the queue 241-ij being included in the queue group 24-i associated with the identified (i-th) network slice. For example, it is assumed that the network slice to which the packet belongs is identified as a first network slice, and that a value of the CoS, which is included in the L2 Ethernet frame, is “1”. In such a case, the distribution unit 23 stores the received packet in a queue associated with a class 1 in a queue group 24-1.

The data transfer unit 25-i acquires the received packet from the queue of the queue group 24-i associated therewith. For example, the data transfer unit 25-1 associated with the first network slice acquires the received packet from a queue 241-1j included in the queue group 24-1, according to a predetermined rule. The data transfer unit 25-i performs the packet transfer processing according to the QoS on the acquired packet. The data transfer unit 25-i transmits the packet to the transmission unit 26.

Note that a correspondence relationship between the data transfer units and the queue groups is stored in advance in a storage unit (not illustrated).

The transmission unit 26 transmits, through the physical port 27, the packet received from the data transfer unit 25-i. In a case of transmitting packets having the same packet priority level, the transmission unit 26 transmits with higher priority the packet received from a data transfer unit associated with a network slice having a higher slice priority level. The slice priority level is a priority level of the network slice. The packet priority level is a priority level set to the packet.

The transmission unit 26 may determine the slice priority level, based on an identification rule at the time of identifying the network slice to which the packet belongs and a correspondence relationship between the network slices and the data transfer units.

In the case of the present example embodiment, the i-th network slice is associated with the data transfer unit 25-i. Such a correspondence relationship between the network slice and the data transfer unit 25-i is stored in advance in the storage unit.

Moreover, the transmission unit 26 may grasp the identification rule at the time of identifying the network slice to which the packet belongs, for example, with reference to the table illustrated in FIG. 5 being used in identifying the network slice.

In the table of FIG. 5, t the network slice number associated with “EF” that indicates an emergency packet to be processed with highest priority is “1”. The transmission unit 26 confirms the key of the table, and may thereby grasp that the slice priority level decreases in order from “1” to “4” of the network slice numbers. Such a correspondence relationship between the keys and the slice priority levels is stored in advance in the storage unit.

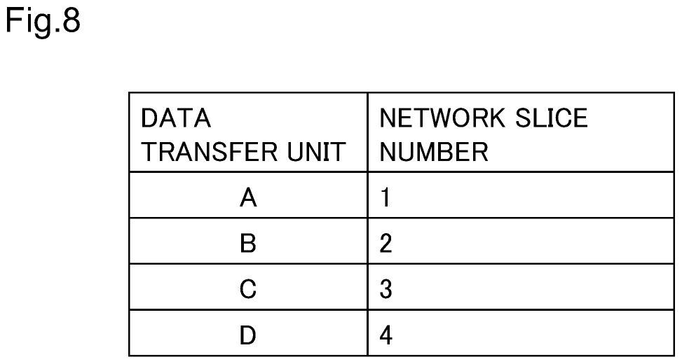

FIG. 8 illustrates an example of a correspondence relationship between the data transfer units and the network slices. This example illustrates that the data transfer unit 25-1 with identification information of “A” is associated with the first network slice.

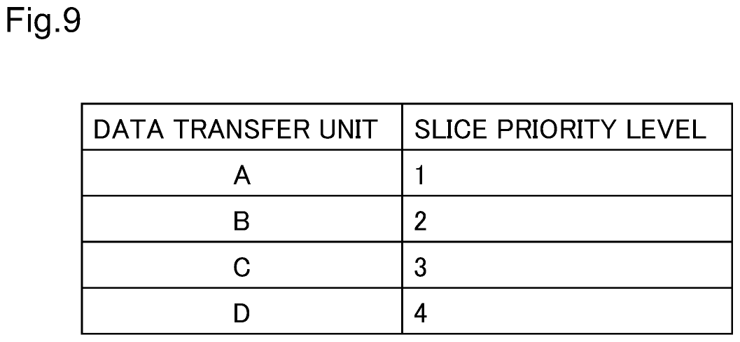

FIG. 9 illustrates an example of the slice priority levels of the data transfer units. The transmission unit 26 is able to determine the slice priority level of the data transfer unit with reference to the table of FIG. 5 and the correspondence relationship of FIG. 8. That is, the transmission unit 26 grasps that the priority level of the data transfer unit 25-1 (identification information: “A”) associated with the first network slice is the highest. Moreover, the transmission unit 26 grasps that the priority level of the data transfer unit 25-4 (identification information: “D”) associated with the fourth network slice is the lowest. Then, the transmission unit 26 determines the slice priority levels of the respective data transfer units as in FIG. 9, and causes the storage unit to store the determined slice priority levels. Note that, in the example of FIG. 9, the slice priority level is higher as the value of the slice priority level is smaller.

As described above, when such information by which the slice priority level can be grasped is included in the key included in the table for use in identifying the network slice, the transmission unit 26 may grasp the slice priority level, based on the key.

The transmission unit 26 may grasp from which data transfer unit the packet has been received based on to which port, among ports provided between the smart NIC 28 and the CPU 29, the packet has been input. Therefore, the identification information of the data transfer unit may be identification information of the port provided between the smart NIC 28 and the CPU 29. In a case of transmitting packets having the same packet priority level, the transmission unit 26 transmits with higher priority the packet received from a data transfer unit 25-i having a higher slice priority level.

Note that, when the table being used in identifying the network slice is the table of FIG. 6, it is difficult to grasp the slice priority level of each network slice from the key. In such a case, it is assumed that the slice priority level of each network slice is stored in advance in the storage unit. The transmission unit 26 may grasp the slice priority level of the data transfer unit 25-i, based on the slice priority level of the network slice and the correspondence relationship between the network slice and the data transfer unit.

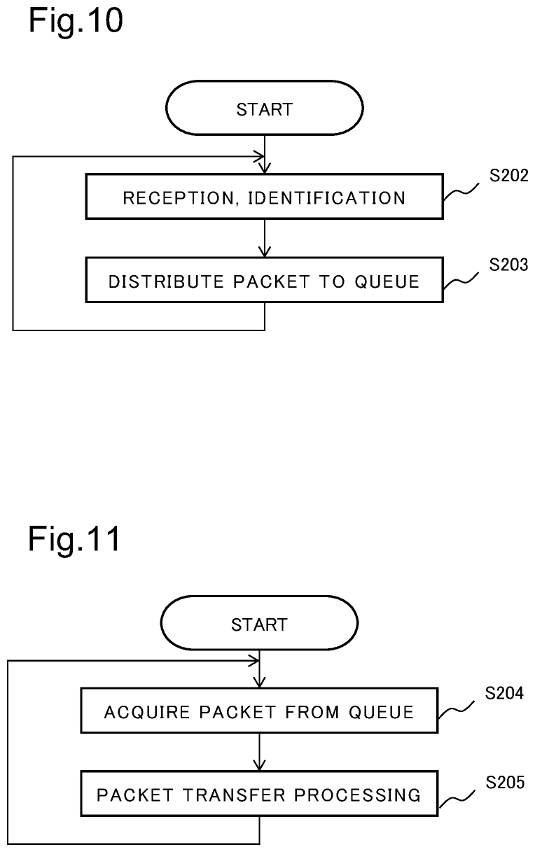

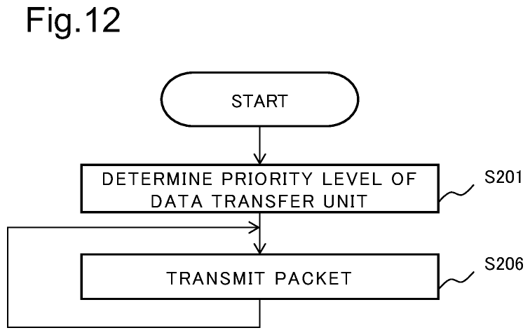

Next, FIGS. 10 to 12 illustrate an example of an operation flow of the communication control device 20 according to the present example embodiment. FIG. 10 is a diagram illustrating an example of an operation flow of the communication control device 20, being related to the reception unit 21, the identification unit 22 and the distribution unit 23. FIG. 11 is a diagram illustrating an example of an operation flow of the communication control device 20, being related to the data transfer unit FIG. 12 is a diagram illustrating an example of an operation flow of the communication control device 20, being related to the transmission unit 26.

First, the transmission unit 26 determines the slice priority level of each data transfer unit 25-i at such predetermined timing as an initial setting time and operation starting time of the communication control device 20 (Step S201 of FIG. 12). The transmission unit 26 may determine the slice priority level of the data transfer unit, based on the identification rule at the time when the identification unit 22 identifies the network slice to which the packet belongs and the correspondence relationship between the network slice and the data transfer unit.

The reception unit 21 receives the packet through the physical port 27. The identification unit 22 identifies, with regard to the received packet, the network slice to which the packet belongs and the class in the QoS (Step S202 of FIG. 10). The distribution unit 23 distributes the received packet to any of the queues in the queue grouping 242 according to the identification result in the identification unit 22 (Step S203).

The data transfer unit 25-i acquires the packet from the queue of the queue group 24-i associated with the data transfer unit 25-i (Step S204 of FIG. 11). The data transfer unit 25-i performs the packet transfer processing according to the QoS on the acquired packet, and transmits the packet thus processed to the transmission unit 26 (Step S205).

The transmission unit 26 transmits the packet, which is received from the data transfer unit 25-i, through the physical port 27 (Step S206 of FIG. 12). The transmission unit 26 transmits with higher priority the packet received from the data transfer unit associated with the network slice with a higher slice priority level.

As described above, in the second example embodiment of the present invention, the communication control device 20 includes the reception unit 21, the identification unit 22, the distribution unit 23, the queue group 24-i, the data transfer unit 25-i and the transmission unit 26. The reception unit 21 receives the packet through the physical port. The identification unit 22 identifies, with regard to the received packet, the network slice to which the packet belongs and the class in the QoS. The distribution unit 23 distributes the packet to any queue of the queue grouping according to the identification result of the packet. The queue grouping has the plurality of queue groups (24-1 to 24-N) associated respectively with each of the plurality of network slices. Each of the queue groups includes the plurality of queues associated respectively with each of the plurality of classes in the QoS. The plurality of data transfer units (25-1 to 25-N) are respectively associated with each of the network slices. The data transfer unit 25-i acquires the packet from the queue of the queue group 24-i associated with the network slice being associated therewith, and performs the packet transfer processing according to the QoS on the acquired packet. The transmission unit 26 transmits packets, which are received from the data transfer units (25-1 to 25-N), through the physical port. The transmission unit 26 transmits the packets while giving priority to a packet received from a data transfer unit associated with a network slice with a higher slice priority level. The slice priority level is a priority level of the network slice.

As described above, the communication control device 20 transmits the packets while giving priority to the packet received from the data transfer unit associated with the network slice with a higher slice priority level. Therefore, it becomes possible to transmit the packets according to the priority levels of the network slices to which the packets belong in the case of accommodating the communications of the plurality of network slices.

Moreover, the transmission unit 26 may determine the slice priority level of the data transfer unit, based on the identification rule at the time of identifying the network slice to which the packet belongs and the correspondence relationship between the network slice and the data transfer unit. Thus, the transmission unit 26 is able to achieve priority control in the transmission unit 26 without identifying the network slice to which the packet belongs one more time.

Moreover, the reception unit 21, the identification unit 22, the distribution unit 23 and the transmission unit 26 are included in the smart NIC 28, and the data transfer unit 25-i is included in the CPU 29. Further, each of the plurality of data transfer units 25-i transmits the packet to the port provided between the smart NIC 28 and the data transfer unit 25-i. Note that the packet is transmitted to a port different for each of the data transfer units. The transmission unit 26 identifies the data transfer unit as a transmission source of the packet, based on the port to which the packet is input. Thus, the transmission unit 26 may identify the data transfer unit being a transmission source of the packet with ease, and grasp the slice priority level of the packet with ease.

Moreover, the communication control device 20 is a UPF. Thus, the communication control device 20 can be applied, for example, to the UPF of the 5G.

### Third Example Embodiment

Next, a communication control device 30 according to a third example embodiment of the present invention will be described.

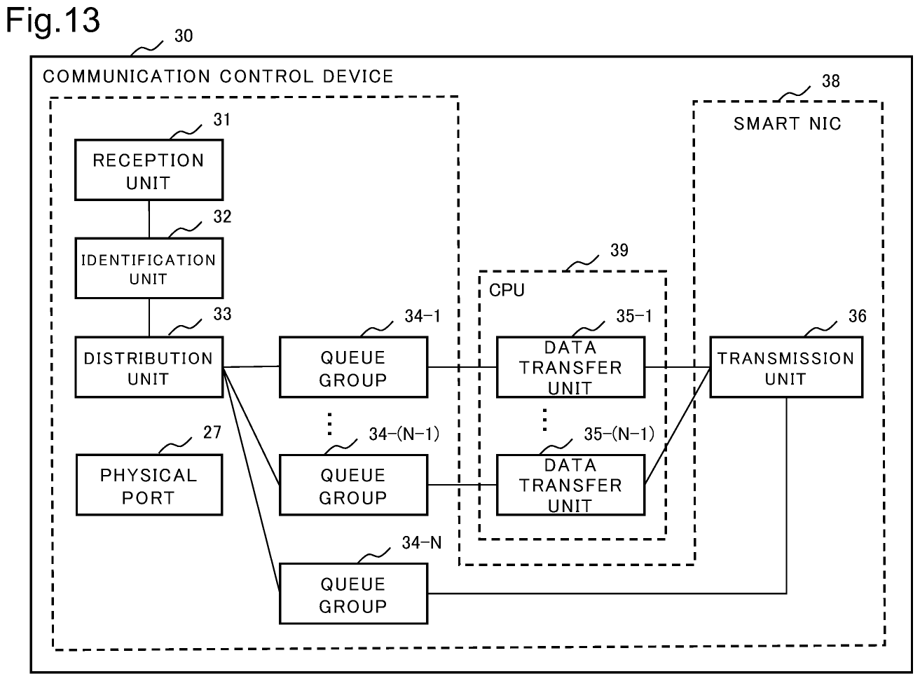

First, FIG. 13 illustrates a configuration example of the communication control device 30 according to the present example embodiment. The communication control device 30 includes a smart NIC 38 and a CPU 39.

The CPU 39 includes data transfer units 35-1 to 35-(N−1). The data transfer unit 35-i is associated with the i-th network slice. In the present example embodiment, the number of network slices is N. Moreover, the N-th network slice is a network slice for a packet to be processed with highest priority. The data transfer units 35-1 to 35-(N−1) are associated with network slices excluding the network slice for the packet to be processed with highest priority.

The data transfer unit 35-i performs packet transfer processing, based on a signal transmitted from an SMF 44. The data transfer unit 35-i performs, in a network slice associated therewith, packet transfer processing according to a QoS. The data transfer unit 35-i acquires a packet from the smart NIC 38, and determines a packet transfer destination and the like. Moreover, the data transfer unit 35-i transmits the packet to an AN 42 or a DN 45 through the smart NIC 38 (a transmission unit 36). The data transfer unit 35-i performs the packet transfer processing according to the QoS in the network slice associated therewith.

The smart NIC 38 includes a reception unit 31, an identification unit 32, a distribution unit 33, a queue group 34-i (i is an integer of 1 to N), the transmission unit 36 and a physical port 27.

The reception unit 31 receives the packet through the physical port 27.

The identification unit 32 identifies, with regard to the packet received by the reception unit 31, the network slice to which the packet belongs and the class in the QoS.

In the smart NIC 38, the queue group 34-i is associated with an i-th network slice. Note that the queue group 34-N is a queue group for a packet to be processed with highest priority.

The distribution unit 33 distributes the packet to any of the queues included in the queue groups 34-1 to 34-N, according to an identification result of the packet in the identification unit 32.

The data transfer unit 35-i acquires the received packet from the queue of the queue group 34-i associated therewith. The data transfer unit 35-i performs the packet transfer processing according to the QoS on the acquired packet. The data transfer unit 35-i transmits the packet to the transmission unit 36.

Note that a correspondence relationship between the data transfer units and the queue groups is stored in advance in a storage unit. However, the queue group 34-N is not associated with the data transfer unit since the queue group 34-N is directly connected to the transmission unit 36.

The transmission unit 36 transmits, through the physical port 27, the packet received from the data transfer unit 35-i. The transmission unit 36 transmits with higher priority the packet received from the data transfer unit associated with to the network slice with a higher slice priority level. Moreover, the transmission unit 36 acquires the packet from the queue group 34-N, and transmits the acquired packet through the physical port 27. At this time, the transmission unit 36 acquires, with higher priority than the packet received from the data transfer unit 35-i, the packet from the queue group 34-N and transmits the acquired packet. The slice priority level of the data transfer unit 35-i is similar to that of the second example embodiment, and accordingly, a description thereof will be omitted.

As described above, the queue group 34-N for the packet to be processed with highest priority is provided, and the transmission unit 36 transmits the packet, which is to be processed with highest priority, without causing such packet to pass through the CPU 39, thus making it possible to transmit, with lower latency, the packet to be processed with highest priority.

However, when there is a mixture of such packets which arrive at the transmission unit 36 from the data transfer unit 35-i and such packets which arrive at the transmission unit 36 from the queue group 34-N, a path of the packets which do not pass through the CPU 39 is shorter than a path of the packets which pass through the CPU 39. Therefore, there is a possibility that an arrival order of the packets at the transmission unit 36 may be changed. As a result, there is a possibility that a bandwidth may become insufficient since the arrival order of the packets at the transmission unit 36 is changed. Usually, it cannot be predicted in which packet a drop or a delay occurs when the bandwidth becomes insufficient. Therefore, there is a possibility that a drop or a delay may occur in the packet to be processed with highest priority.

The transmission unit 36 of the present example embodiment transmits, with higher priority than the packet received from the data transfer unit 25-I, the packet received from the queue group 34-N. Therefore, even when there is a mixture of such packets which arrive at the transmission unit 36 from the data transfer unit 35-i and such packets which arrive at the transmission unit 36 from the queue group 34-N, the possibility that a drop or a delay may occur in the packet to be processed with highest priority can be reduced.

Next, an operation flow of the communication control device 30 according to the present example embodiment will be described. The operation flow of the communication control device 30 of the present example embodiment is similar to that of the second example embodiment (FIGS. 10 to 12). However, in Step S206 of FIG. 12, the transmission unit 36 acquires, with higher priority than the packet received from the data transfer unit 35-i, the packet from the queue group 34-N and transmits the acquired packet.

As described above, in the third example embodiment of the present invention, the communication control device 30 includes the reception unit 31, the identification unit 32, the distribution unit 33, the queue group 34-i, the data transfer unit 35-i and the transmission unit 36. The reception unit 31 receives the packet through the physical port. The identification unit 32 identifies, with regard to the received packet, the network slice to which the packet belongs and the class in the QoS. The distribution unit 33 distributes the packet to any queue of the queue grouping according to the identification result of the packet. The queue grouping has the plurality of queue groups (34-1 to 34-N) associated with each of the plurality of network slices. Each of the queue groups includes the plurality of queues respectively associated with each of the plurality of classes in the QoS. The plurality of data transfer units (35-1 to 35-N) are respectively associated with each of the network slices. The data transfer unit 35-i acquires the packet from the queue of the queue group 34-i associated with the network slice associated therewith, and performs the packet transfer processing according to the QoS on the acquired packet. The transmission unit 36 transmits packets, which are received from the data transfer units (35-1 to 35-N), through the physical port. The transmission unit 36 transmits the packets while giving priority to the packet received from the data transfer unit associated with the network slice having a higher slice priority level. The slice priority level is a priority level of the network slice.

As described above, the communication control device 30 transmits the packets while giving priority to the packet received from the data transfer unit associated with the network slice having a higher slice priority level. Therefore, it becomes possible to transmit the packets according to the priority levels of the network slices to which the packets belong in the case of accommodating the communications of the plurality of network slices.

Moreover, the distribution unit 33 distributes the packet, which belongs to the network slice for the packet to be processed with highest priority, to the queue of the queue group for the packet to be processed with highest priority. Moreover, the transmission unit 36 acquires the packet from the queue group 34-N for the packet to be processed with highest priority, and transmits the acquired packet while giving higher priority thereto than to the packet received from the data transfer unit. Thus, it becomes possible to transmit, with lower latency, the packet to be processed with highest priority. Moreover, the possibility that a drop or a delay may occur in the packet to be processed with highest priority can be reduced.

[Hardware Configuration Example]

A description will be given of a configuration example of a hardware resource that achieves the communication control device (10, 20, in each of the above-mentioned example embodiments of the present invention by using one information processing apparatus (a computer). Note that the communication control device may be achieved by using at least two information processing apparatuses physically or functionally.

Further, the communication control device may be achieved as a dedicated device. In addition, only a function of a part of the communication control device may be achieved by using the information processing apparatus.

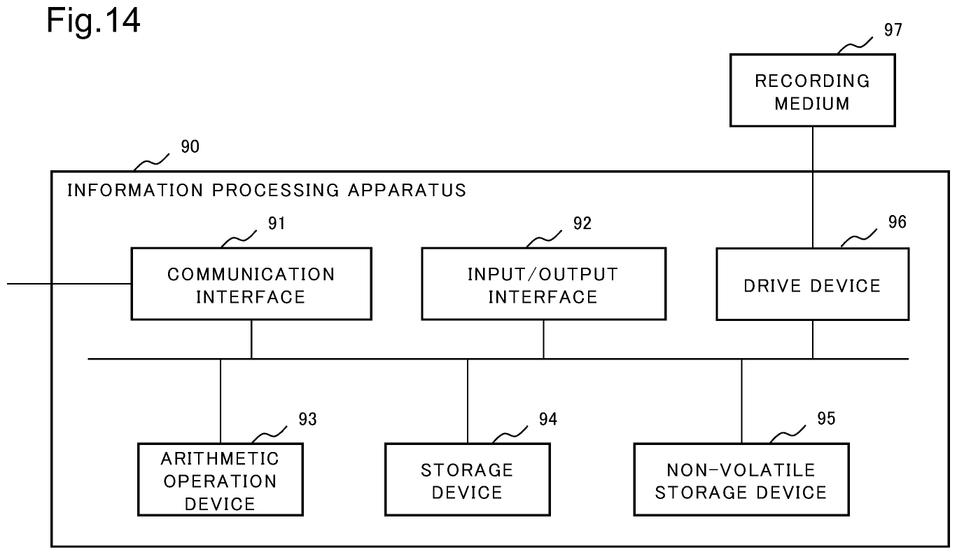

FIG. 14 is a diagram schematically illustrating a hardware configuration example of the information processing apparatus capable of achieving the communication control device of each of the example embodiments of the present invention. An information processing apparatus 90 includes a communication interface 91, an input/output interface 92, an arithmetic operation device 93, a storage device 94, a non-volatile storage device 95, and a drive device 96.

For example, it is possible to achieve the reception unit 11 of FIG. 1 by the communication interface 91. It is possible to achieve the identification unit 12, the distribution unit 13 and the data transfer unit 15-i by the arithmetic operation device 93. It is possible to achieve the queue group 14-i by the storage device 94. It is possible to achieve the transmission unit 16 by the communication interface 91 and the arithmetic operation device 93.

The communication interface 91 is a communication means for causing the communication control device of each of the example embodiments to communicate with an external device in a wired and/or wireless manner. Note that, when the communication control device is achieved by using at least two information processing apparatuses, these apparatuses may be connected to each other in such a way as to be communicable with each other via the communication interface 91.

The input/output interface 92 is a man-machine interface such as a keyboard as one example of an input device and a display as an output device.

The arithmetic operation device 93 is achieved by an arithmetic operation device such as a general-purpose central processing unit (CPU) or a microprocessor and a plurality of electrical circuits. The arithmetic operation device 93 is capable of reading out, for example, a variety of programs stored in the non-volatile storage device 95, into the storage device 94, and executing processing in accordance with the program thus read out.

The storage device 94 is a memory device such as a random-access memory (RAM) capable of being referred to from the arithmetic operation device 93, and stores the program, a variety of data, and the like. The storage device 94 may be a volatile memory device.

The non-volatile storage device 95 is, for example, a non-volatile storage device such as a read only memory (ROM) and a flash memory, and is capable of storing varieties of programs, data, and the like.

The drive device 96 is, for example, a device that processes data reading and writing with a recording medium 97 to be described later.

The recording medium 97 is any recording medium capable of recording data, such as, for example, an optical disk, a magneto-optical disk, and a semiconductor flash memory.

For example, each of the example embodiments of the present invention may be achieved in such a way that the communication control device is configured of the information processing apparatus 90 illustrated in FIG. 14, and that such communication control device is supplied with a program capable of achieving a function described in each of the above-described example embodiments.

In such a case, the arithmetic operation device 93 executes the program supplied to the communication control device, thus making it possible to achieve the example embodiments. Moreover, it is also possible to configure not all of the communication control device but a partial function thereof by the information processing apparatus 90.

Moreover, the communication control device may be configured such that the above-described program is recorded in the recording medium 97 in advance, and that the above-described program is stored in the non-volatile storage device 95, as appropriate, in a shipping stage, an operating stage or the like of the communication control device. Note that, as a supply method of the above-described program in such a case, there may be adopted a method for installing the program in the communication control device by using an appropriate jig in a manufacturing stage before shipment, the operating stage or the like. Moreover, the supply method of the above-described program may adopt a general procedure such as a method for downloading the program from the outside through a communication line such as the Internet.

The whole or part of the example embodiments disclosed above can be described as, but not limited to, the following supplementary notes.

(Supplementary Note 1)

A communication control device including:
a reception unit configured to receive a packet through a physical port;
an identification unit configured to identify, with regard to the received packet, a network slice to which the packet belongs and a class of the packet in a Quality of Service (QoS);
a distribution unit configured to distribute the packet to any of queues of a queue grouping, according to an identification result of the packet, the queue grouping including a plurality of queue groups associated with each of a plurality of the network slices, the plurality of queue groups each including a plurality of the queues associated with each of a plurality of classes in the QoS;
a plurality of data transfer units each being provided to each of a plurality of the network slices and configured to perform packet transfer processing according to the QoS in the associated network slice; and
a transmission unit configured to transmit, through a physical port, the packet received from the data transfer unit, wherein
each of a plurality of the data transfer units acquires the packet from the queue included in the queue group associated with the network slice associated with the data transfer unit, and performs the packet transfer processing according to the QoS on the acquired packet, and
the transmission unit transmits, with higher priority, the packet received from, among a plurality of the data transfer units, the data transfer unit associated with the network slice having a higher slice priority level being a priority level of the network slice.

(Supplementary Note 2)

The communication control device according to Supplementary note 1, wherein
the transmission unit determines the slice priority level of the data transfer unit, based on an identification rule at a time of identifying the network slice to which the packet belongs, and a correspondence relationship between the network slice and the data transfer unit.

(Supplementary Note 3)

The communication control device according to Supplementary note 1, wherein
the distribution unit distributes the packet belonging to a network slice for a packet to be processed with highest priority, to a queue included in a queue group for the packet to be processed with highest priority, and
the transmission unit acquires a packet from the queue group for the packet to be processed with highest priority, and transmits the acquired packet while giving higher priority to the acquired packet than the packet received from the data transfer unit.

(Supplementary Note 4)

The communication control device according to any one of Supplementary notes 1 to 3, wherein
the reception unit, the identification unit, the distribution unit, and the transmission unit are included in a smart network interface card (NIC), and the data transfer unit is included in a central processing unit (CPU).

(Supplementary Note 5)

The communication control device according to Supplementary note 4, wherein
each of a plurality of the data transfer units transmits the packet to a port different for each of the data transfer units, the port being provided between the smart NIC and the data transfer unit, and
the transmission unit identifies the data transfer unit being a transmission source of the packet, based on the port to which the packet is transmitted by the data transfer unit.

(Supplementary Note 6)

The communication control device according to any one of Supplementary notes 1 to 3, wherein
the communication control device is a user plane function (UPF).

(Supplementary Note 7)

A communication control method including:
receiving a packet through a physical port;
identifying, with regard to the received packet, a network slice to which the packet belongs and a class of the packet in a QoS;
distributing the packet to any of queues of a queue grouping according to an identification result of the packet, the queue grouping including a plurality of queue groups associated with each of a plurality of the network slices, the plurality of queue groups each including a plurality of the queues associated with each of a plurality of classes in the QoS;
in a data transfer unit provided to each of a plurality of the network slices, acquiring the packet from the queue included in the queue group associated with the network slice associated with the data transfer unit, and performing packet transfer processing according to the QoS on the acquired packet; and
transmitting, with higher priority through a physical port, the packet received from, among a plurality of the data transfer units, the data transfer unit associated with the network slice having a higher slice priority level being a priority level of the network slice.

(Supplementary Note 8)

The communication control method according to Supplementary note 7, further including
determining the slice priority level of the data transfer unit, based on an identification rule at a time of identifying the network slice to which the packet belongs, and a correspondence relationship between the network slice and the data transfer unit.

(Supplementary Note 9)

The communication control method according to Supplementary note 7, further including:
distributing the packet belonging to a network slice for a packet to be processed with highest priority, to a queue included in a queue group for the packet to be processed with highest priority; and
acquiring a packet from the queue group for the packet to be processed with highest priority, and transmitting, through a physical port, the acquired packet while giving higher priority to the acquired packet than a packet received from the data transfer unit.

(Supplementary Note 10)

The communication control method according to any one of Supplementary notes 7 to 9, wherein
the communication control method is a method for a communication control device,
the communication control device includes a smart NIC and a CPU, and
the data transfer unit is included in the CPU.

(Supplementary Note 11)

The communication control method according to Supplementary note 10, further including:
transmitting, by each of a plurality of the data transfer units, the packet to a port different for each of the data transfer units, the port being provided between the smart NIC and the data transfer unit; and
identifying the data transfer unit being a transmission source of the packet, based on the port to which the packet is transmitted by the data transfer unit.

(Supplementary Note 12)

The communication control method according to any one of Supplementary notes 7 to 9, wherein
the communication control method is a method for a UPF.

(Supplementary Note 13)

A non-transitory computer-readable recording medium that records a communication control program causing a computer to achieve:
a reception function of receiving a packet through a physical port;
an identification function of, with regard to the received packet, identifying a network slice to which the packet belongs and a class of the packet in a QoS;
a distribution function of distributing the packet to any of queues of a queue grouping according to an identification result of the packet, the queue grouping including a plurality of queue groups associated with each of a plurality of the network slices, the plurality of queue groups each including a plurality of the queues associated with each of a plurality of classes in the QoS;
a plurality of data transfer functions, each being provided to each of a plurality of the network slices, of performing packet transfer processing according to the QoS in the associated network slice; and
a transmission function of transmitting, through a physical port, the packet received from the data transfer function, wherein
each of a plurality of the data transfer functions acquires the packet from the queue included the queue group associated with the network slice associated with the data transfer function, and performs the packet transfer processing according to the QoS on the acquired packet, and
the transmission function transmits, with higher priority, the packet received from, among a plurality of the data transfer functions, the data transfer function associated with the network slice having a higher slice priority level being a priority level of the network slice.

(Supplementary Note 14)

The non-transitory computer-readable recording medium that records the communication control program according to Supplementary note 13, wherein
the transmission function determines the slice priority level of the data transfer function, based on an identification rule at a time of identifying the network slice to which the packet belongs, and a correspondence relationship between the network slice and the data transfer function.

(Supplementary Note 15)

The non-transitory computer-readable recording medium that records the communication control program according to Supplementary note 13, wherein
the distribution function distributes the packet belonging to a network slice for a packet to be processed with highest priority, to a queue included in a queue group for the packet to be processed with highest priority, and
the transmission function acquires a packet from the queue group for the packet to be processed with highest priority, and transmits the acquired packet while giving higher priority to the acquired packet than a packet received from the data transfer function.

(Supplementary Note 16)

The non-transitory computer-readable recording medium that records the communication control program according to any one of Supplementary notes 13 to 15, wherein
the communication control program is a communication control program for a communication control device,
the communication control device includes a smart NIC and a CPU, and
the data transfer function is included in the CPU.

(Supplementary Note 17)

The non-transitory computer-readable recording medium that records the communication control program according to Supplementary note 16, wherein
each of a plurality of the data transfer functions transmits the packet to a port different for each of the data transfer functions, the port being provided between the smart NIC and the CPU, and
the transmission function identifies the data transfer function being a transmission source of the packet, based on the port to which the packet is transmitted by the data transfer function.

(Supplementary Note 18)

The non-transitory computer-readable recording medium that records the communication control program according to any one of Supplementary notes 13 to 15, wherein
the communication control program is a communication control program for a UPF.

While the invention has been particularly shown and described with reference to example embodiments thereof, the invention is not limited to these embodiments. It will be understood by those of ordinary skill in the art that various changes in form and details may be made therein without departing from the spirit and scope of the present invention as defined by the claims.

1. A communication control device comprising:
a reception unit configured to receive a packet through a physical port;
an identification unit configured to identify, with regard to the received packet, a network slice to which the packet belongs and a class of the packet in a Quality of Service (QoS);
a distribution unit configured to distribute the packet to any of queues of a queue grouping, according to an identification result of the packet, the queue grouping including a plurality of queue groups associated with each of a plurality of the network slices, the plurality of queue groups each including a plurality of the queues associated with each of a plurality of classes in the QoS;
a plurality of data transfer units each being provided to each of a plurality of the network slices and configured to perform packet transfer processing according to the QoS in the associated network slice; and
a transmission unit configured to transmit, through a physical port, the packet received from the data transfer unit, wherein
each of a plurality of the data transfer units acquires the packet from the queue included in the queue group associated with the network slice associated with the data transfer unit, and performs the packet transfer processing according to the QoS on the acquired packet, and
the transmission unit transmits, with higher priority, the packet received from, among a plurality of the data transfer units, the data transfer unit associated with the network slice having a higher slice priority level being a priority level of the network slice.

2. The communication control device according to claim 1, wherein
the transmission unit determines the slice priority level of the data transfer unit, based on an identification rule at a time of identifying the network slice to which the packet belongs, and a correspondence relationship between the network slice and the data transfer unit.

3. The communication control device according to claim 1, wherein
the distribution unit distributes the packet belonging to a network slice for a packet to be processed with highest priority, to a queue included in a queue group for the packet to be processed with highest priority, and
the transmission unit acquires a packet from the queue group for the packet to be processed with highest priority, and transmits the acquired packet while giving higher priority to the acquired packet than the packet received from the data transfer unit.

4. The communication control device according to claim 1, wherein
the reception unit, the identification unit, the distribution unit, and the transmission unit are included in a smart network interface card (NIC), and the data transfer unit is included in a central processing unit (CPU).

5. The communication control device according to claim 4, wherein
each of a plurality of the data transfer units transmits the packet to a port different for each of the data transfer units, the port being provided between the smart NIC and the data transfer unit, and
the transmission unit identifies the data transfer unit being a transmission source of the packet, based on the port to which the packet is transmitted by the data transfer unit.

6. The communication control device according to claim 1, wherein
the communication control device is a user plane function (UPF).

7. A communication control method comprising:
receiving a packet through a physical port;
identifying, with regard to the received packet, a network slice to which the packet belongs and a class of the packet in a QoS;
distributing the packet to any of queues of a queue grouping according to an identification result of the packet, the queue grouping including a plurality of queue groups associated with each of a plurality of the network slices, the plurality of queue groups each including a plurality of the queues associated with each of a plurality of classes in the QoS;
in a data transfer unit provided to each of a plurality of the network slices, acquiring the packet from the queue included in the queue group associated with the network slice associated with the data transfer unit, and performing packet transfer processing according to the QoS on the acquired packet; and
transmitting, with higher priority through a physical port, the packet received from, among a plurality of the data transfer units, the data transfer unit associated with the network slice having a higher slice priority level being a priority level of the network slice.

8. The communication control method according to claim 7, further comprising
determining the slice priority level of the data transfer unit, based on an identification rule at a time of identifying the network slice to which the packet belongs, and a correspondence relationship between the network slice and the data transfer unit.

9. The communication control method according to claim 7, further comprising:
distributing the packet belonging to a network slice for a packet to be processed with highest priority, to a queue included in a queue group for the packet to be processed with highest priority; and
acquiring a packet from the queue group for the packet to be processed with highest priority, and transmitting, through a physical port, the acquired packet while giving higher priority to the acquired packet than a packet received from the data transfer unit.

10. A non-transitory computer-readable recording medium that records a communication control program causing a computer to achieve:
a reception function of receiving a packet through a physical port;
an identification function of, with regard to the received packet, identifying a network slice to which the packet belongs and a class of the packet in a QoS;
a distribution function of distributing the packet to any of queues of a queue grouping according to an identification result of the packet, the queue grouping including a plurality of queue groups associated with each of a plurality of the network slices, the plurality of queue groups each including a plurality of the queues associated with each of a plurality of classes in the QoS;
a plurality of data transfer functions, each being provided to each of a plurality of the network slices, of performing packet transfer processing according to the QoS in the associated network slice; and
a transmission function of transmitting, through a physical port, the packet received from the data transfer function, wherein
each of a plurality of the data transfer functions acquires the packet from the queue included in the queue group associated with the network slice associated with the data transfer function, and performs the packet transfer processing according to the QoS on the acquired packet, and
the transmission function transmits, with higher priority, the packet received from, among a plurality of the data transfer functions, the data transfer function associated with the network slice having a higher slice priority level being a priority level of the network slice.
